(19) United States
(12) Patent Application Publication
(10) Pub. No.: US 2007/0170056 A1
(43) Pub. Date: Jul. 26, 2007

(54) Microscale electrochemical cell and methods incorporating the cell

(76) Inventors: Don W. Arnold, Livermore, CA (US); Guifeng Jiang, Sunnyvale, CA (US); Nicole E. Hebert, Dublin, CA (US)

Correspondence Address: EKSIGENT TECHNOLOGIES, LLC;c/o SHELDON MAK ROSE & ANDERSON, 100 East Corson Street, Third Floor, PASADENA, CA, 91103-3842, US

(21) Appl. No.: 11/341,221

(22) Filed: Jan. 26, 2006

(51) Int. Cl. G01N 27/26

(52) U.S. Cl. 204/412

(57) ABSTRACT

An electrochemical cell for processing a sample fluid, has a body with a flow path, the flow path having an inlet and an outlet; a reference electrode in fluid communication with the flow path; a counter electrode in fluid communication with the flow path; a porous working electrode in fluid communication with the flow path, the working electrode having a working electrode material; an electrical connection for the working electrode in electrical contact with the working electrode; and a working electrode section in the flow path. The working electrode is positioned inside the working electrode section. The working electrode section has a volume of from about 1 pL to about 1 μL.

### STATEMENT REGARDING FEDERALLY SPONSORED RESEARCH OR DEVELOPMENT

This invention was made with United States Government support under 70NANB3H3048 awarded by the National Institute of Standards and Technology (NIST). The United States Government has certain rights in the invention.

### BACKGROUND

The present invention is directed to electrochemical detectors, and more specifically to microscale electrochemical detectors.

Microscale separations such as capillary liquid chromatography (LC) and capillary electrophoresis (CE) offer shorter analysis times, low reagent and solvent consumption, increased reliability and high performance over traditional separations. The use of microfluidic devices to perform these types of separations provides advantages in instrumental integration and portability. The increasing popularity of capillary LC and CE over the last 25 years, and the more recent transition to microfluidic devices in the last 15 years, has created a need for detection systems that are amenable to miniaturization. Due to the low flow rates (tens of nL/min to tens of μL/min) and very small volumes used in capillary LC and CE (tens of nL), these systems must provide very high mass sensitivity (pmol or less) and chemical selectivity, and have the ability to measure analytes of interest in intended applications without prior chemical derivatization. Additionally, detectors should be easy to use, possess high stability and reproducibility, and be easily fabricated in appropriate dimensions at a reasonable cost.

Electrochemical detection is very mass sensitive. Many analytes, including many pharmaceutical drugs and endogenous neurotransmitters or neuroactive compounds, are natively electrochemically active which allows them to be measured by electrochemical detection. Electrochemical detection scales very well with reduced sample volume, making it amenable to miniaturization.

One previous separation method involves the use of microelectrodes. See Nyholm, L., The Analyst, 2005, 130(5), 599-605; “Electrochemical techniques for lab-on-a-chip applications”; Vandaveer, W. R. et al., Electrophoresis, 2004, 25, 3528-3549; “Recent developments in electrochemical detection for microchip capillary electrophoresis”; and Wang, J.; Talanta, 2002, 9, 223-231; “Electrochemical detection for microscale analytical systems: a review.” Other previous detection systems for flowing streams, such as HPLC, include coulometric detectors such as CoulArray from ESA, Inc., also discussed in U.S. Pat. Nos. 4,404,065, 4,511,659, 4,753,714 4,804,455, and 6,475,799.

Prior art detection systems suffer from one or more of the following deficiencies. A low electrode surface area to solution volume ratio is present, leading to low efficiency of oxidation or reduction reaction, because of inadequate interaction with the sample. Additionally, a small surface area subjects the devices to rapid fouling which requires frequent cleaning and maintenance by skilled users to maintain operation. Some detection systems are not amenable to use with microscale separation methods due to the excessive surface area and large volumes employed in these devices. Moreover, the method of manufacture of some detection systems is not amenable to microfabrication.

Additionally, existing microscale approaches to electrochemical detection do not offer the robustness or quantitation required for use in an analytical laboratory setting. Therefore, a need exists for improved microscale separation detection systems and methods.

### SUMMARY

The present invention is directed to a novel electrochemical cell that is suited to microanalysis and that overcomes deficiencies in the prior art. The invention is also directed to systems incorporating the cell and a method for cell manufacture.

An electrochemical cell for processing a sample fluid according to an embodiment of the present invention has a monolithic body having a flow path, the flow path having an inlet and an outlet. A reference electrode and a counter electrode are in fluid communication with the flow path. A porous working electrode is in fluid communication with the flow path, the working electrode comprising a working electrode material. An electrical connection for the working electrode is in electrical contact with the working electrode. The flow path has a working electrode section, the working electrode being positioned inside the working electrode section. The working electrode section has a volume of from about 1 pL to about 1 μL.

The cell can also have a filling conduit in fluid communication with the working electrode section for placement of the working electrode material. The working electrode section can be bounded by weirs, the weirs allowing passage of sample fluid and blocking passage of the working electrode material. The body can comprise fused silica. The working electrode can comprise particles having a diameter of from about 10 nm to about 100 μm and can comprise at least one of carbon, copper, gold, palladium, silver, platinum, indium tin oxide, and tin oxide.

The reference electrode and the counter electrode can comprise non-reactive metal wire having a diameter of from about 5 μm to about 500 μm. The reference electrode and the counter electrode can comprise palladium, platinum or silver and can comprise a porous polymeric coating. The cell can also have a second reference electrode and a second counter electrode in fluid communication with the flow path.

The present invention is also directed to an electrochemical detection system incorporating one or more electrochemical cells. An electrochemical detection system according to an embodiment of the present invention has a circuit board; an electrochemical cell electrically coupled to the circuit board; a preamplifier electrically connected to the circuit board and the cell; a connector electrically connected to the preamplifier; and a housing surrounding the circuit board, the preamplifier and the connector. The system can also have one or more of: a liquid chromatography column in fluid communication with the flow path inlet; a mass spectrometer in fluid communication with the flow path outlet; a second electrochemical cell positioned upstream or downstream of the electrochemical cell; a light source, and a light detector.

The present invention is also directed to an array of electrochemical cells having a monolithic body comprising silica and a flow path, the flow path having an inlet and an outlet. The array may have from about 2 to about 16 working electrodes.

The present invention is also directed to a method for making an electrochemical cell. A monolithic body is formed having a fluid manifold, the fluid manifold having a flow path, a working electrode section in the flow path, a filling conduit in communication with the working electrode section, and a plurality of secondary conduits in communication with the flow path. A working electrode material is packed into the working electrode section through the filling conduit to create a working electrode. The filling conduit is sealed with electrically non-reactive material.

A reference electrode is mounted in a first of the secondary conduits. A counter electrode is mounted in a second of the secondary conduits. An electrical connection to the working electrode is mounted in a third secondary conduit. The secondary conduits are sealed with an electrically non-reactive material. The working electrode section has a volume of from about 1 pL to about 1 μL.

Optionally, forming the body further includes microfabricating weirs defining the working electrode section. The body may be formed using photolithography.

### BRIEF DESCRIPTION OF THE DRAWINGS

A better understanding of the present invention will be had with reference to the accompanying drawings in which:

FIG. 1 is a top sectional view of an electrochemical cell according to a first embodiment of the present invention;

FIG. 2 is a cross-sectional view of the electrochemical cell of FIG. 1 taken along line 2-2;

FIG. 3 is a top sectional view of an electrochemical cell according to a second embodiment of the present invention;

FIG. 4 is a cross-sectional view of the electrochemical cell of FIG. 3 taken along line 4-4;

FIG. 5a is a top sectional view of an electrochemical cell according to a third embodiment of the present invention;

FIG. 5b is a top sectional view of an electrochemical cell according to a fourth embodiment of the present invention;

FIG. 5c is a top sectional view of an electrochemical cell according to a fifth embodiment of the present invention;

FIG. 6a is a top sectional view of an electrochemical cell according to a sixth embodiment of the present invention;

FIG. 6b is a top sectional view of an electrochemical cell according to a seventh embodiment of the present invention;

FIG. 7 is a top sectional view of an array having two electrochemical cells;

FIG. 8 is a cross-sectional view of an electrochemical system according to an embodiment of the present invention;

FIG. 9 is a schematic diagram of an analysis system utilizing a microscale electrochemical system in conjunction with liquid chromatography according to an embodiment of the present invention;

FIG. 10 is a schematic diagram of a liquid chromatography-electrochemical system utilizing an upstream electrochemical system as a microreactor to cleanse a mobile phase;

FIG. 11 is a schematic diagram of a liquid chromatography-electrochemical system having a first system functioning as a microreactor to oxidize or reduce an analyte of interest;

FIG. 12 is a schematic diagram of a system incorporating an electrochemical system of the present invention in conjunction with a mass spectrometer;

FIG. 13 is a schematic diagram of an electrochemiluminescence detection system incorporating an electrochemical cell of the present invention;

FIG. 14 is a schematic diagram of a photoelectrochemical detection system incorporating an electrochemical cell of the present invention and a light source;

FIG. 15 is a schematic diagram of an in vivo microdialysis system utilizing an electrochemical cell of the present invention;

FIG. 16 is a schematic diagram showing the use of an electrochemical cell of the present invention as an electrochemical immunoassay sensor;

FIG. 17 is a schematic diagram showing the use of multi-channel separation columns and the electrochemical cells to perform a flow through protein immunoassay;

FIG. 18 is a plot of electrical charging current as a function of time for two different electrochemical cells according to present invention;

FIG. 19 is a plot illustrating the separation and detection of phenol (1), 4-chloro-3-methylphenol (2), 2-chlorophenol (3), 2,4-dimethylphenol (4) and 2,4-dichlorophenol (5) from a sample utilizing electrochemical cells according to present invention;

FIG. 20a is a plot illustrating the separation and oxidation of ascorbic acid (6), norepinephrine (7), epinephrine (8) and dopamine (9) from a sample by a first electrochemical cell according to the present invention and reduction of the quasi-reversible catecholamines by a second electrochemical cell according to the present invention;

FIG. 20b is a plot illustrating separation and detection of ascorbic acid (6), norepinephrine (7), epinephrine (8) and dopamine (9) from a sample using two electrochemical cells according to the present invention, with one of the cells functioning as a pretreatment cell to remove ascorbic acid;

FIG. 20c is a plot illustrating separation and detection of ascorbic acid (6), norepinephrine (7), epinephrine (8) and dopamine (9) from a sample using three electrochemical cells according to the present invention with staggered electrical potentials;

FIG. 21 is a plot illustrating separation and detection of morphine (10), codeine (11), 6-acetyl-morphine (12), ethyl-morphine (13), cocaine (14) and hydrocodone (15) from a sample utilizing electrochemical cells according to the present invention.

### DETAILED DESCRIPTION

The present invention is directed to electrochemical cells, systems and methods incorporating the electrochemical cells and methods for making the electrochemical cells. Such systems can include a microscale electrochemical detector comprising flow-through, high-efficiency, low dispersion, quantitative, sensitive electrochemical cells in a microfabricated chip.

The electrochemical cell of the present invention overcomes obstacles for the use of electrochemical detection in conjunction with microscale samples whether in a stand-alone mode or as a detector for use in conjunction with microscale separation systems. The electrochemical cell provides exceptional performance in a small cell volume, for example 1 to 20 nL, and allows measurement of very sharp, very low-volume peaks. It provides operability within a very short period after system startup by virtue of its significantly decreased electrode settling time, or the time required for the electrode response to stabilize. An electrochemical cell according the present invention provides a means for carrying out quantitative electrochemical analysis on microscale samples in a robust, user-friendly format.

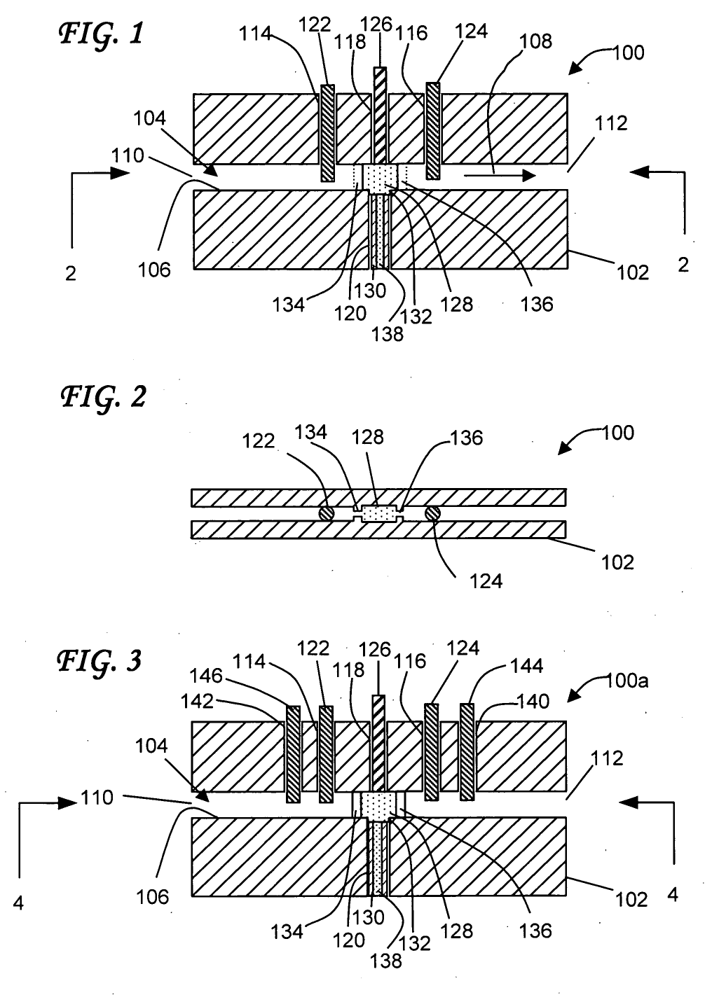

An electrochemical cell 100 according to a first embodiment of the present invention is illustrated in FIGS. 1 and 2. The cell 100 has a body 102 containing a fluidic manifold 104. The manifold 104 has a primary flow path 106 through which a sample fluid transits the cell in the direction of arrow 108. The flow path 106 has an inlet 110 and an outlet 112, and is in fluid communication with at least two secondary conduits, and in the version of FIGS. 1 and 2, four secondary conduits 114, 116, 118, 120. The secondary conduits are used for electrode assemblies.

The secondary conduits can include, for example, the first conduit 114 for placement of a reference electrode 122, the second conduit 116 for the placement of a counter electrode 124, the third conduit 118 for placement of an electrical connection 126 to a working electrode 128, and the fourth conduit 120 serving as a filling conduit for introducing materials for the working electrode 128. A silica capillary 130 can be placed in the filling conduit 120. A working electrode section 132 for placement of the working electrode 128 is fabricated in the flow path 106. The length of the working electrode section 132 along the flow path 106 is limited by dimensions of the working electrode or by weirs 134, 136, located in the primary flow path 106 upstream and downstream of the working electrode section 132.

The working electrode 128 comprises a conductive, porous electrode material. Preferably, the working electrode is located in the working electrode section 132 such that all of a sample fluid that transits the flow path 106 passes through the working electrode section 132 and the working electrode 128. The weirs 134, 136 allow passage of a sample fluid, but prevent passage of the material used for the working electrode 128. The cell 100 can be operated by placing the reference electrode 122 upstream or downstream of the working electrode 128 along the flow path 106. Likewise, the counter electrode 124 can be placed upstream or downstream of the working electrode 128. Alternatively, the reference 122 and counter electrodes 124 can both be placed upstream or downstream of the working electrode 128.

Preferably, the cell body 102 is manufactured from fused silica. Alternatively, the cell body can be microfabricated using any of a number of different materials, including glasses, such as Soda-Lime, Low-Iron, Corning Pyrex®, Corning 0211, and Schott Borofloat®, plastics such as PDMS, PMMA, Polyimide, cyclic polyolefins, perfluoropolyethers, and polypropylene. The cell can be manufactured using a number of different manufacturing methods, such as injection molding, embossing and laser machining. Preferably, the cell body 102 is a transparent, monolithic body within which is formed the microfluidic manifold 104 with ports for fluidic and electrical connections as required for the various disclosed detection schemes.

During operation, fluid enters through the inlet 110 and exits from the outlet 112. The fluid interfaces to the inlet 110 and the outlet 112 can be made by any of a number of means. Examples are a microconnector as described in PCT Patent Application No. PCT/2005/011021 and U.S. Pat. Nos. 6,319,476, 6,605,472, 6,620,625, and 6,832,787, the entire contents of which are hereby incorporated herein by reference. Additionally, the interfaces can be made by glued-in capillaries.

The working electrode 128 is a porous electrode through which the sample fluid flows. The porosity of the working electrode 128 can be inherent to the material or can be created by packing porous or non-porous particulate material into the working electrode section 132. If the working electrode material is porous, then preferably the material is produced in situ in the working electrode section 132 and is formed to eliminate gaps at the electrode section walls. If the working electrode consists of particulate material, then the particles are preferably approximately spherical and of a narrow size distribution.

Examples of materials that can be used for the working electrode 128 include graphite particles, glassy carbon particles, carbon aerogel particles, carbon nanotubes, particles of gold, copper, nickel, silver, platinum, palladium, diamond, and boron nitride. When carbon aerogel particles are used, the aerogel particles can also contain a metal such as cesium, zinc, chromium, iron, cobalt, nickel, or tungsten to enhance performance. Composite or coated particles can be used to achieve optimal particle size distributions and conductive properties.

The working electrode can be fabricated by packing porous, conductive particles inside the working electrode section 132 through the filling conduit 120, then sealing the filling conduit with electrically, and preferably chemically, non-reactive material 138, such as an epoxy or silicone glue. Alternatively, the filling conduit can be filled with electrically, and preferably chemically, non-reactive particles, such as silica particles for example, prior to sealing with the non-reactive material. Particles for the working electrode 128 can be introduced through filling conduit 120 using a connecting port as described in Patent Cooperation Treaty Application No. PCT/2005/011021, the entire contents of which are hereby incorporated herein by reference. Alternatively, a capillary 130 can be glued into the filling conduit 120 to provide a chip-to-world interface through which the conductive particles can be introduced. Additionally, once the particles have been placed in the working electrode section, they can be electroplated with a metal, such as platinum, palladium, or gold, providing rigidity and improved electrical conductivity for the working electrode.

The cell volume can be from about 1 pL to about 1 μL. For operation with capillary or chip-based separation systems, such as liquid chromatography, capillary electrophoresis, or capillary electrochromatography, the preferred volume is from about 100 pL to about 50 nL. As used herein, the term “cell volume” refers to the volume of the working electrode section without the working electrode material. As discussed below in detail, because the cells can be geometrically patterned, the cell volume may be precisely determined.

The working electrode particle size can be from about 10 nm to about 100 μm in diameter. The particles are preferably spherical in shape and uniform in size and from about 1 μm to about 15 μm in diameter. Relative to thin film electrodes, the larger surface area provided by the tightly packed spheres improves the efficiency of the electrochemical reaction, thereby increasing the signal generation from a sample. Although the electrode area is large when compared to that of amperometric cells, it is much smaller than that used in conventional coulometric cells, and therefore improves the signal to noise ratio for small volume samples.

The reference electrode 122 and the counter electrode 124 are preferably made of materials that are non-reactive with the sample fluid. For example, the reference electrode 122 and the counter electrode 124 can be metals such as palladium, platinum or silver, which can have a coating, such as porous Teflon, cellulose, or Nafion that serves as a diffusion barrier. The diameter range of the electrodes is preferably from about 5 μm to about 500 μm and more preferably from about 5 μm to about 125 μm. Preferably, the counter electrode 124 and reference electrode 122 comprise metal wires. In an embodiment, platinum wires, which serve as the reference electrodes 122, the counter electrodes 124 and the electrical connection 126 to the working electrode 128, are placed into their conduits and sealed with an electrically, and preferably chemically, non-reactive material (not shown) to prevent fluid leakage from the cell, with only a terminal of the electrode materials exposed to the primary flow path.

The reference electrodes 122 and the counter electrodes 124 can also be thin film electrodes, such as those formed by microfabrication. Additionally, the reference electrode 122 and the counter electrode 124 can be a bed of packed spheres of a conductive material similar to the working electrode. When a reference or counter electrode is a bed of packed particles, additional weirs in the primary flow path allow a sample fluid to pass the electrode, but restrict passage of the electrode particles.

Additionally, semiconducting particles, such as indium tin oxide and tin oxide, can be used for electrodes, such as the working electrode, when illumination of the cell is desired for photoelectrochemical detection studies. Preferably the electrode materials used for photoelectrochemical and electrochemiluminescence detection methods are substantially optically transparent at the wavelengths used for the detection method.

The electrical connection to the working electrode can be any wire material that is non-reactive with the sample fluid. Although the sample fluid contact area with the electrical connection material is negligible with respect to the working electrode area, it is preferred to use a non-reactive material to avoid unwanted side reactions. For example, carbon fiber or other non-reactive metallic wires can be used as long as good electrical properties are inherent to the material and a good connection to the working electrode can be established.

### ADDITIONAL EMBODIMENTS

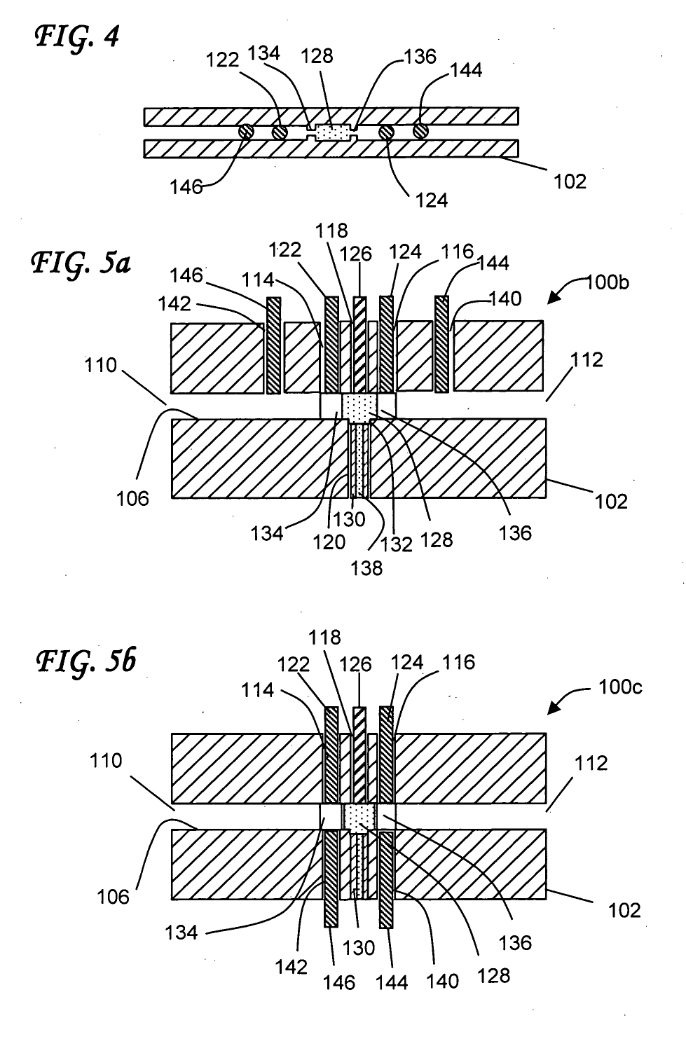

The same reference numeral is used for the same element throughout the drawings. The number of counter and reference electrodes is not limited to one each per cell. A cell 100a according to a second embodiment of the present invention is shown in FIGS. 3 and 4. The second embodiment is a 5-electrode design with two additional secondary conduits 140, 142 in fluid communication with the flow path 106. Each secondary conduit 140, 142 contains an electrode 144, 146. The additional electrodes can function as counter or reference electrodes. This design allows for symmetry in the cell that helps provide more uniform electrical fields through the working electrode 128 and improved performance.

To reduce dead volume, the portion of the working electrode unswept by sample passing through the primary flow path, and the uncompensated resistance of the cell 100a, one or more of the reference and counter electrodes can be placed in the weir region, instead of being placed outside of the weir region along the primary flow path 106. A larger uncompensated resistance leads to increased inaccuracies and requires more voltage at the counter electrode thereby leading to gas formation and response time problems.

A cell 100b according to a third embodiment of the present invention is illustrated in FIG. 5a. As shown in FIG. 5a, the cell 100b has two reference electrodes 122, 144 and two counter electrodes 124, 146, one of each being in the weir region. The weirs 134, 136 can be the same weirs used to retain the working electrode material or it can be a separate weir structure (not shown).

In the design of FIG. 5a, two improvements for cell performance are obtained compared to the embodiment of FIG. 1. First, the dead volume around the reference electrode is reduced, thereby reducing peak dispersion. Second, the distance between the working electrode and the reference electrode is reduced compared to the first embodiment, resulting in lower uncompensated resistance.

A cell 100c according to a fourth embodiment of the present invention is shown in FIG. 5b. The cell 100c has two reference electrodes 122, 144 and two counter electrodes 124, 146. For both of the reference electrodes 122, 144 and both of the counter electrodes 124, 146 weirs are fabricated between the electrode conduit and the flow path. This further reduces the dead volume of the cell to enhance the performance of the cell.

A cell 100d according to a fifth embodiment of the present invention is shown in FIG. 5c. The cell 100d has one reference electrode 122 and two counter electrodes 124, 146. The reference electrode 122 and both of the counter electrodes 124, 146 are separated from the flow path by weirs. The reference electrode 122 is located between the two counter electrodes 124, 146 and proximal to the working electrode 128. The filling conduit 120 is split to provide electrical connection to the working electrode 126.

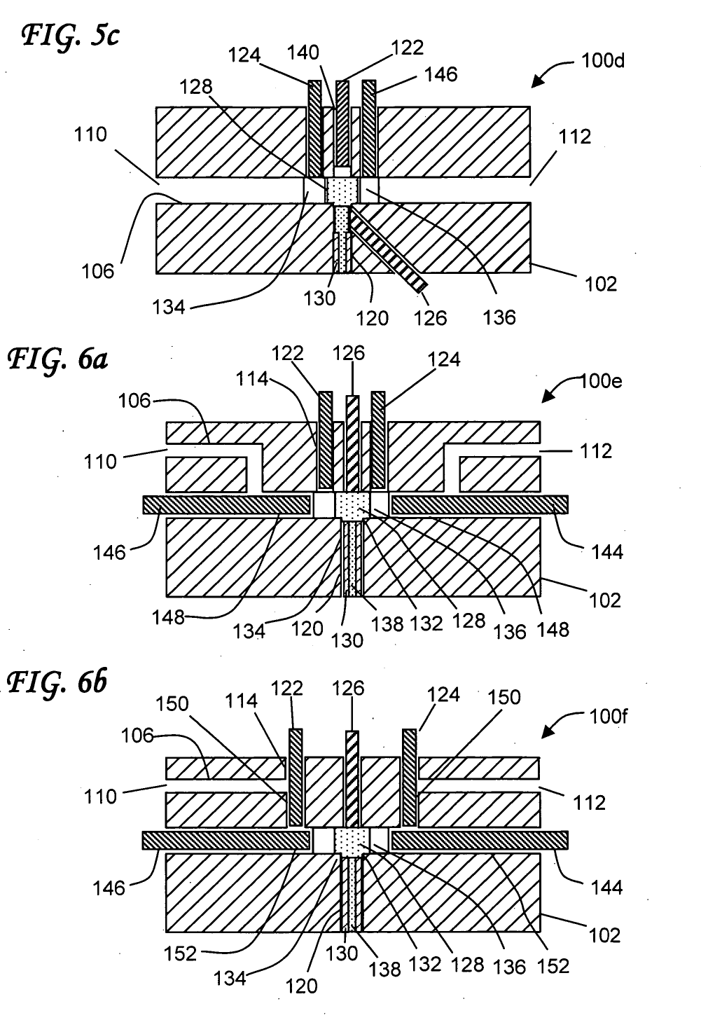

In additional embodiments of the present invention, the flow of the sample fluid is altered to improve performance. Electrochemical cells 100e, 100f according to sixth and seventh embodiments of the present invention are shown in FIGS. 6a and 6b respectively. In the sixth embodiment, the primary flow path 106 is modified so that sample fluid flows through annular regions 148 around two of the reference or counter electrodes both of which are cylindrically shaped. In the seventh embodiment, the primary flow path is modified so that sample fluid flows through annular regions 150, 152 around all four of the cylindrical reference and counter electrodes. Because the flow sweeps the active area of the electrodes, electrolysis products generated during detection are removed, and dispersion is reduced relative to placement of the electrodes at right angles in the flow stream.

The cells described above can be used alone, or in series, forming an array through which the sample fluid flows sequentially. When an array of cells is used as a detection system for liquid chromatography, signal intensity is collected as a function of two parameters. One parameter is the analyte retention time, or elution time from the liquid chromatography column. The second parameter is the operating potential, V. The resultant hydrodynamic voltammogram (HDV), a plot of peak height vs. V for a peak at a constant retention time, represents an electrochemical fingerprint of sample analytes. An HDV can be constructed through the use of amperometry, but this requires multiple sequential analyses of a sample at different applied potentials.

In a serial array of cells according to the present invention, the potential is staggered across the array of cells and all the necessary information can be gathered in one analysis, significantly reducing analysis time. In this way, knowledge of the profile of an analyte allows for discrimination of species that cannot be separated chromatographically, a task that is impossible using amperometry due to its low efficiency of oxidation or reduction.

When an array of cells is used, the potentials applied to each individual cell can be varied to achieve numerous goals. The working electrodes are typically of a very high surface area to volume ratio, which can allow for coulometric detection. The coulometric efficiency of the working electrode can be advantageous for other applications, such as use as a gating electrode.

For example, discrimination based on electrochemical reversibility can be achieved by applying a large positive potential (such as greater than about 2 volts) on one of the two first cells in an array and a large negative potential (such as greater than about −2 volts) on the other, thereby eliminating the possibility of further reaction by irreversible species at subsequent cells, and allowing only reversible species to be observed. Additionally, an array of coulometrically efficient cells can be used with applied potentials staggered at intervals, such as 60 mV. Each species reacts only in the cells that are held at a potential high or low enough to oxidize or reduce them, respectively. The high efficiency of the cells ensures that the signal is only seen on at most 5 electrodes, after which the oxidation/reduction is complete. This generates two-dimensional information when coupled with HPLC; one axis looking like a conventional chromatogram, and the other an HDV. Species can be identified by retention time as well as oxidation/reduction potential.

Additionally, electrochemical cells according to the present invention can be used as a pre-concentration or pre-separation unit, taking advantage of the high surface area (greater than about 5×10⁻⁴ cm²) of the working electrode to selectively capture particular analytes in a complex mixture, which, after removal of interfering species, are subsequently eluted out of the working electrode and further separated, such as by HPLC, or detected by a detector.

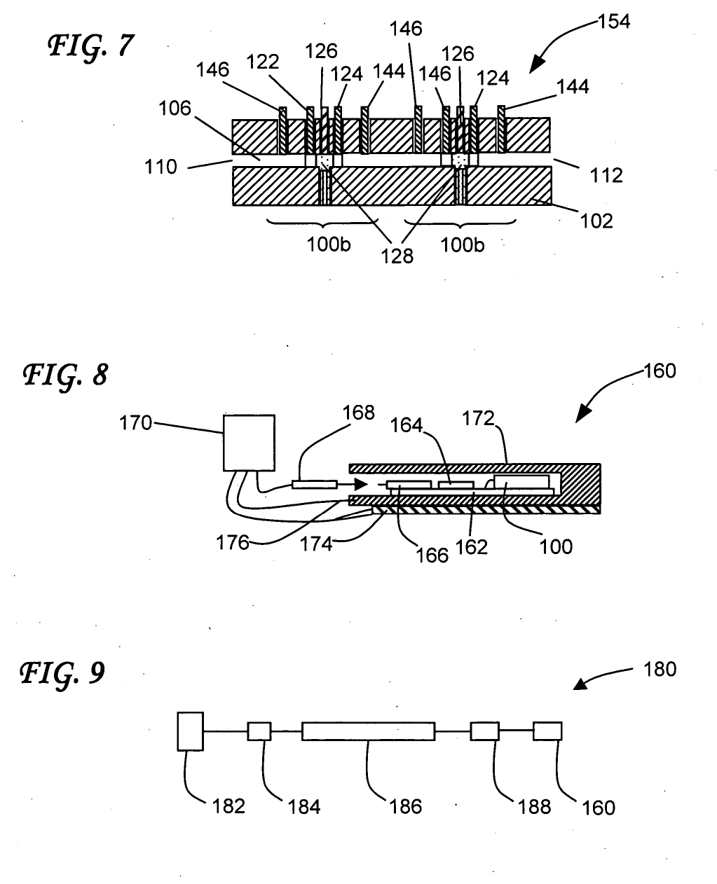

While several individual cells can be connected in series to provide the detector array capabilities described above, microfabrication allows integration of several cells into a single device without the need for connections between the cells. FIG. 7 shows a two-cell array 154 according to an embodiment of the present invention. As shown in FIG. 7, each cell 100b has a working electrode 128, reference electrodes 124, 144 and counter electrodes 122, 146. In the embodiment shown in FIG. 7, the array has only one fluidic inlet 110 and one fluid outlet 112, the connection between the cells being made through a connecting section of the primary flow path 106. Additionally, a group of cells connected in series can be arranged in parallel for parallel processing to increase throughput.

An array can consist of numerous cells of the same design, or of cells with different designs in a single body. A microfabricated array can contain from 1 to 16 or more working electrodes. Preferably, a microfabricated array contains from 1 to 8 working electrodes.

The electrochemical cells of the present invention have numerous advantages over the prior art. For example, the porous particle packed working electrode has a large surface area, but the volumetrically constrained cell design limits background noise, thereby increasing the signal to noise ratio and improving detection limits. The extremely low volume of the electrochemical cell results in very high electrode surface area to solution volume ratio, improving the rate and efficiency of the electrochemical reactions, which provides a detection apparatus with a large linear dynamic range, good reproducibility, long-term stability and reliability. The cell time constant, which is a function of the capacitance of the double layer formed at the working electrode/solution interface and the uncompensated resistance of the cell, is reduced significantly with the present cell design. The reduced cell time constant leads to a faster response and allows for the accurate measurement of narrow analyte bands as they transit the electrode cell.

By shrinking the size, and therefore the surface area, of the working electrode, the capacitance is reduced proportionally. By moving the reference electrode tip as close as possible to the working electrode, such as within 5-50 μm, the uncompensated resistance between the reference electrode and working electrode is reduced substantially. After start-up, a detection system using one or more electrochemical cells according to the present invention can be operational after a period of approximately 15 seconds, in contrast to existing large commercial electrochemical detection systems that can require almost an hour settling time to equilibrate the cells. The extremely low dead volume reduces peak dispersion caused by the detection system, making this an excellent detection scheme for analytes in conjunction with systems that operate in μL/min or nL/min flow rate regimes.

The geometry of the coulometric cell has very low dead volume, thereby lowering the dispersion of each cell and allowing the cells to be used in series with minimal detrimental effect on the volume and spatial distribution of a sample as it moves through each sequential cell. The large area of the working electrode allows it to perform reproducibly for a long period of time before fouling, after which it can be regenerated, or due to the low cost associated with these devices, simply thrown away. This is contrary to amperometric systems, which foul quickly and must be cleaned or regenerated often. A microfluidic-based coulometric array offers a sensitive, selective detection system for fast, high efficiency separations.

Several different uses of the of the electrochemical cells of the present invention will now be described with reference to the cell of the first embodiment. It will be understood that different electrochemical cells can be substituted, such as those described with reference to FIGS. 3 to 6b.

Electrochemical Detection Systems

The electrochemical cells of the present invention can be operated alone or in conjunction with a number of different analytical systems. While simple electrical connections such as clips can be made to the cell electrodes, optimization of the connections, signal conditioning and overall signal and fluid input and output can significantly improve the performance of the system.

FIG. 8 shows a diagram of an electrochemical system 160 according to an embodiment of the present invention. An electrochemical cell 100 is mounted on a circuit board 162 using, for example, an adhesive, bracket, or other fastening means. Electrical connections are made from the cell 100 to the circuit board 162 utilizing a means known in the art, such as soldering, clamping, staking, crimping, the use of screw terminals, conductive epoxy, spring loaded pins or ball bonding. These connections can be reversible. The circuit board 162 contains proximal preamplifier circuitry 164 and a board mounted connector 166 that mates to a connector 168 on a cable that carries a preamplified signal to a control and data acquisition system 170. Preferably, the control and data acquisition system 170 has signal conditioning and amplification circuitry.

The cell 100, circuit board 162, preamplifier circuitry 164 and a connector 166 are contained within a shielded housing 172. Preferably a heater 174 and temperature sensor 176 are mounted to the housing 172 for controlling the temperature of the housing. Increasing the temperature of the cells can change adsorption behavior and modify the kinetics of electron transfer. The low thermal mass of the device facilitates its thermal control by the control and data acquisition system. Alternatively, the thermal control portion of the system can be in direct contact with the cell to provide the ability for rapid changes in temperature.

Microscale electrochemical systems according to the present invention can be combined with other detection and analysis methods. Microscale electrochemical systems can be used in combination with any liquid separation technique, such as liquid chromatography, capillary electrophoresis, capillary electro-chromatography, capillary liquid chromatography, microbore liquid chromatography, and microfabricated chip-based liquid chromatography.

FIG. 9 is a schematic diagram of an analysis system 180 utilizing the microscale electrochemical system 160 in conjunction with liquid chromatography. As seen in FIG. 9, such a system 180 comprises a solvent delivery system 182, a sample injector 184, a liquid chromatography column 186 and the electrochemical detection system 160. In combination with liquid chromatography, the detection system 160 can provide electrochemical signal intensity as a function of elution time and redox potential.

Other detection systems can be used in combination with the electrochemical system 160. For example, the electrochemical system 160 can be used upstream of secondary detectors, such as mass spectrometers, to monitor reaction products or to remove analytes that create unwanted background signal for a secondary method of detection. The electrochemical system 160 can also be used in tandem with other forms of detection to provide complementary information about the original analytes. Because operation of the system 160 is destructive for a number of species that undergo irreversible electron transfer, the detection system is preferably used as a downstream tandem detector. Examples of other non-destructive detection methods include absorbance, laser induced fluorescence, refractive index, and conductivity. Optionally, the liquid chromatography-electrochemical detection system in FIG. 9 contains a non-destructive detector 188 between the separation column 186 and the electrochemical system 160.

Preferably, a stand-alone electrochemical system, comprising electronics known in the art, is utilized with one or more electrochemical cells on a substrate with electrodes as previously described and a connection system that provides: adequate electrical connectivity to proximal pre-amplification circuitry; shielding from RF and other electronic noise; the ability to replace cells as necessary; fluid access through a sample inlet and outlet through chip-to-world interfaces; and temperature control.

Microfabricated electrochemical systems according to the present invention are physically strong, can be handled easily, due to their higher surface area have less fouling than thin film electrodes, and are inexpensive enough for use in disposable devices. Additionally, microfabricated electrochemical systems feature rapid response (from less than about 1 millisecond to about 1 second), low dispersion, high sensitivity (can sense concentrations at least as low as 1 femtomol), large dynamic range of detectable concentrations from about 1 femtomol to about 10 picomoles, and small volumes (from less than 1 nL to about 50 nL.

Additional Applications

Background Analyte Suppression

The electrochemical cells of the present invention can be used in conjunction with other detectors. For example, the cells can be used in background analyte suppression. Often, the mobile phases for liquid chromatography contain trace level contaminants that are electrochemically active and contribute a background signal to an electrochemical detection system, thereby adversely affecting performance. Electrochemical cells can be utilized upstream of a liquid chromatography column and injector to consume electrochemically active species in the mobile phase to reduce background electrochemical signal during liquid chromatography analyses.

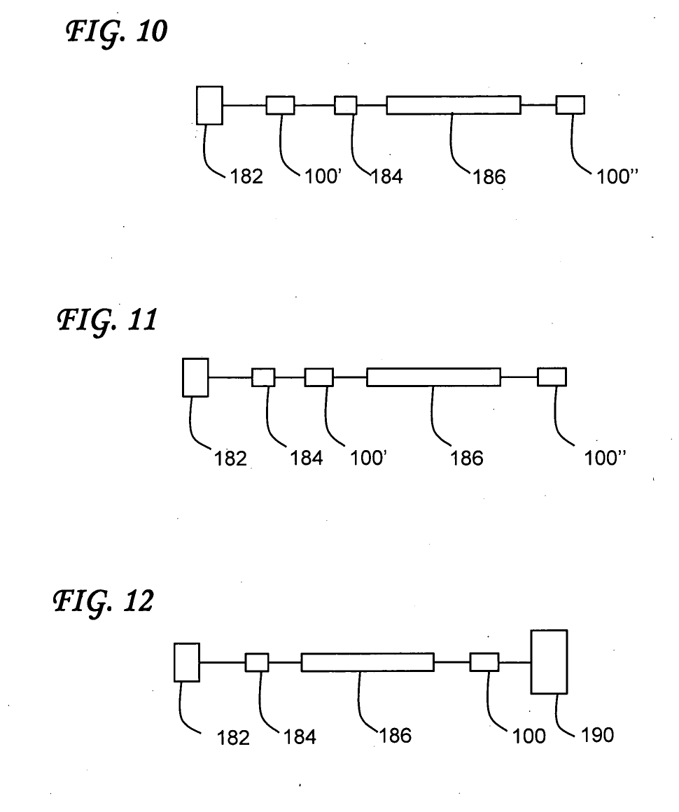

FIG. 10 is a schematic diagram of a system utilizing an upstream electrochemical cell 100′ to cleanse the mobile phase of a liquid chromatography-electrochemical detection system. As seen in FIG. 10, a solvent delivery module 182 passes the mobile phase through a first electrochemical cell 100′. The mobile phase then passes through the sample injector 184 and the liquid chromatography column 186 and a second electrochemical cell 100″. By placing the first electrochemical cell upstream of sample injection, a high potential, such as greater than ±2 volts, can be used for ‘cleaning’ the mobile phase without affecting the signal-providing sample.

Use as a Microreactor

Electrochemical cells according to the present invention provide an efficient electrochemical conversion apparatus due to the high surface area of the working electrode. Thus, the electrochemical cells according to the present invention can be used as microreactors for a variety of applications. The electrochemical cell of the present invention can be used as an efficient microreactor for conversion of inert chemicals to electrochemically-generated reactive species that can be used for further chemical synthesis steps downstream of the reactor. Similarly, sample species can be converted to photodetectable species to enhance detection capabilities. This effect can be enhanced through combination with a microscale mixer.

An electrochemical cell according to the present invention can be used as a microreactor in several different modes with a liquid chromatography system. For example, as shown in FIG. 10, the electrochemical cell 100′ upstream of the injector 184 and the column 186 can function as a microreactor. In this way, reaction, separation and detection are performed in one system.

Additionally, as shown in FIG. 11, a first electrochemical cell 100′ can be placed between the injector 184 and the column 186 as a microreactor to oxidize or reduce an analyte of interest before the analyte passes through a second electrochemical cell 100″. This can change the chromatographic character of the analyte, which can result in better separations. This technique can also be used to convert the analyte to a species that is measurable by another detection technique, such as the oxidation of phenols to produce fluorescently active oligomers as taught by Meyer, J. et al., Analytical Chemistry, 2003, 75, 922-926. “Liquid chromatography with on-line electrochemical derivatization and fluorescence detection for the determination of phenols,” the entire contents of which are hereby incorporated herein by reference. This effect can be enhanced through combination with a microscale mixer.

An electrochemical cell functioning as a conversion apparatus can be used in conjunction with mass spectrometry for ADME/Tox profiling (absorption, distribution, metabolism, excretion, toxicity). Many clinically important properties of pharmaceuticals involve oxidation or reduction of the parent compound, as explained by Gamache, P. et al., Spectroscopy, 2003, 18 (6), 14-21, “ADME/Tox profiling: Using coulometric electrochemistry and electrospray ionization mass spectrometry,” the entire contents of which are hereby incorporated herein by reference. As shown in FIG. 12, an electrochemical cell 100 can be placed downstream of the liquid chromatography column 186 and upstream of a mass spectrometer 190. The electrochemical cell 100 functions as a microreactor to oxidize or reduce the parent compound; the products then being studied by analysis on the mass spectrometer 190. Mass spectrometry detection can occur immediately, as would be the case with an electrospray (ESI), chemical ionization (CI) or photoionization (PI) interface.

Alternatively, mass spectrometry detection can be separated from chemical analysis using a deposition system for the eluent from the electrochemical cell. A matrix assisted laser desorption ionization (MALDI) interface can be used to prepare the eluent for mass spectrometry detection. Typically, mass spectrometry suffers from a phenomenon known as ion suppression, wherein one molecule is preferentially ionized over other molecules of study, based upon factors such as ionization potentials and electron affinities of the molecules involved. Placing an electrochemical cell functioning as an electrochemical converter before a mass spectrometer provides a means to investigate any species suppressed by the matrix while the oxidation/reduction products were not. Thus, the electrochemical cell functioning as an electrochemical converter opens a wider range of analytes for mass spectrometry analysis.

Use as a Preconcentrator

An electrochemical cell according to the present invention can also be used to concentrate a dilute sample prior to analysis. In this capacity, the working electrode is a preconcentration device upon which molecule adsorption is effected. Diluted sample can be collected on the surface of the electrode by physical or chemical adsorption, with the working electrode at no applied potential or held at ground, due to hydrophilic/hydrophobic interactions. Alternatively, adsorption can be effected by applying potential to the electrode to increase the interaction of molecules with the surface of the electrode material through a phenomenon known as electrosorption. The preconcentrated sample can then be quickly released into a flowing stream by applying an appropriate potential. The preconcentration cell is preferably placed upstream of the separation column or electrochemical detectors for analysis of the sample.

As an extension of the preconcentration mode of operation, the electrochemical cells can be used to separate a mixture of analytes, because the applied potential on the surface of the working electrode can affect the desorption isotherm of the molecules. The electrochemical cell can serve as an electrochemical differentiator for the separation of molecules according to their different desorption behavior under the applied potential, as described in Ponton, L. M. et al., Analytical Chemistry, 2004, 76, 5823-5828, “High-speed electrochemically modulated liquid chromatography,” the entire contents of which are hereby incorporated herein by reference. After loading samples, the potential of the working electrode is varied and differential desorption of the samples is achieved. This preseparation is very useful when handling a complicated matrix of real world samples, such as for environmental analysis. A separation column can be added before or after the cell functioning as an electrochemical separator for enhanced separation performance.

The present invention provides an electrochemical detection apparatus capable of responding not only to charge transfer of the species in a sample solution, but also to the capacitance of the electrical double layer created when the solid working electrode sits in the sample solution. The capacitance of the double layer is very sensitive to the composition and the concentration of the liquid sample solution. The electrochemical cell of the present invention is capable of measuring charge transfer and changes of the electrical double layer in a sample solution.

Electrochemiluminescence Detection Cell:

Electrochemiluminescence (“ECL”) is the production of light by an oxidation or reduction reaction at an electrode surface, thereby allowing background-free signal generation in a defined location. ECL is used as a very sensitive detection method for the detection of certain classes of compounds, such as alkyl amines, amino acids, oxalates, various antihistamine drugs, etc. Typically, in an ECL system, an electron to photon converting species, such as luminol or tris(2′,2′-bipyridyl)ruthenium(II) chloride (“Ru(bpy)”), is used to generate the photons to be detected. Light generation occurs when a chemical reaction occurs between the luminescent molecule and the molecule to be detected. In the case of Ru(bpy), as an example, the luminescent species is electrochemically recycled, meaning that a reactive version of Ru(bpy), and perhaps the detectable species, is prepared for reaction through electrochemical oxidation (˜1.1 V for Ru (bpy). The two species react to form a luminescent form of the Ru(bpy) which emits a photon (˜610 nm) as it relaxes back to the ground state and is ready for another cycle.

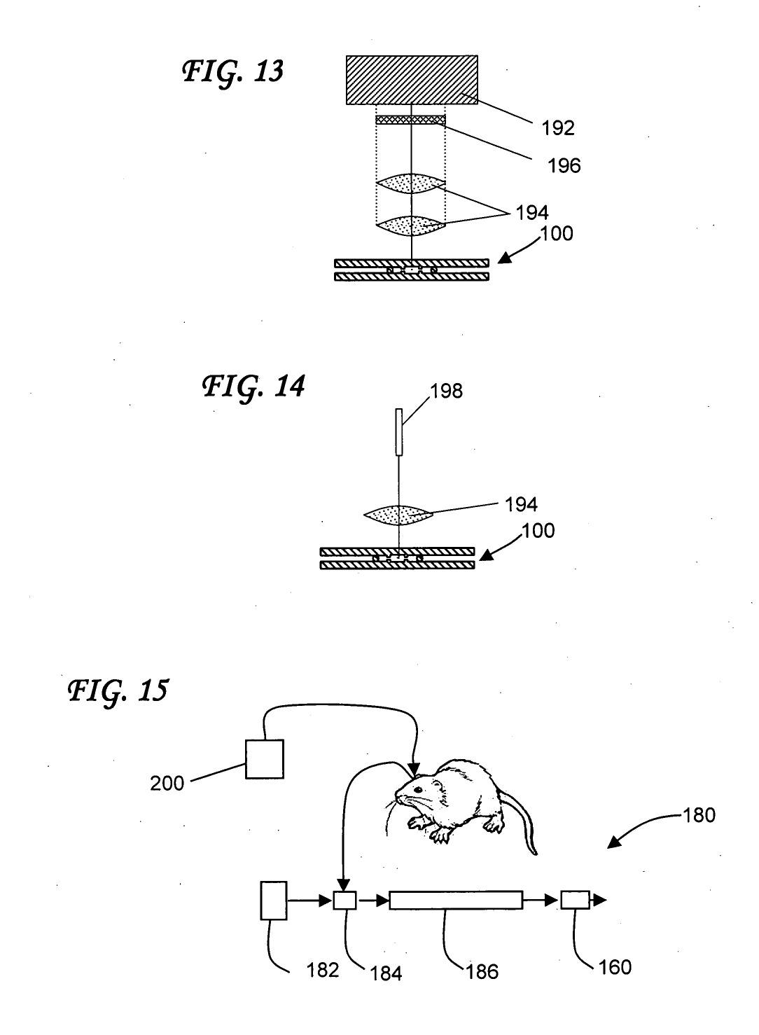

FIG. 13 is a schematic diagram showing the implementation of an electrochemical cell 100 according to the present invention in an ECL detection system. Electrochemical cells fabricated in a transparent, low-fluorescence material, such as silica, are suitable for use in an ECL detection system. As used herein, the term “transparent” means transmitting at least 20% of detectable or excitation light. As seen in FIG. 13, the electrochemical cell 100 is used in conjunction with a light detector 192, such as a photodiode, photomultiplier tube, or CCD, lenses 194, and a filter 196.

Optionally, light can be collected using an embedded fiber optic inserted into an additional secondary conduit designed into the fluidic manifold that is proximal to the light-generating working electrode. Insertion of an embedded fiber optic into a fluid manifold is disclosed in US Patent Publication No. 2004-0197043, the entire contents of which are hereby incorporated herein by reference. Additionally, a dispersive element, such as a prism or grating, can be inserted into the system to obtain spectral information about the emitting species.

Additionally, the cell can be used to generate fluorescent species that can then be detected using an excitation light source to generate detectable fluorescent emission light. In sum, the cell can be used to generate a luminescent species that is either chemiluminescent or that emits a fluorescent excitation light in response to an excitation light.

Photoelectrochemical Detection System:

In a photoelectrochemical detection system, light is used to convert an analyte (or tagged analyte) to one that is readily reduced or oxidized at a working electrode.

Ru(bpy)₃²⁺ is a preferred reagent for this type of detection. As with ECL, an advantage of performing this analysis with the electrochemical cells of the present invention is that the high surface area of the working electrode combined with the photon to electrical signal conversion of the method provide decoupled excitation and detection mechanisms. This leads to reduced background noise and better signal to noise ratios.

Addition of a light source 198 for illumination of the working electrode region of the electrochemical cell allows the device to be used as a photoelectrochemical detection cell. FIG. 14 is a schematic diagram of a photoelectrochemical detection system having a light source 198. Optionally, illumination can be provided and light can be collected using embedded fiber optics inserted into additional channels in the fluidic manifold that are proximal to the working electrode as described above.

Microdialysis Detection System:

It is known to use electrochemical detection for analysis of catecholamine neurotransmitters, their metabolites, and other extracellular fluid-based analytes. When coupled with a means of extracting such fluids from a living creature, such as a microdialysis system, one can measure the neurochemical responses to various drug treatments and correlate the responses to the animal's behavior. The small sample volumes generated by microdialysis make analysis by conventionally-sized high performance liquid chromatography systems difficult, because conventionally-sized systems require a large volume of sample for adequate sensitivity. In collecting these large volume samples, the information content of the sample is averaged and the temporal resolution of the analysis is severely compromised.

FIG. 15 is a schematic diagram of a system in which in vivo microdialysis is utilized to sample the extracellular fluid of an animal. The sample is transported to the electrochemical analysis system 180 for sensitive and rapid analyses, and high temporal resolution. The system has a solvent delivery system 200, which can be, for example, a syringe pump. Additionally, for high accuracy nanoliter flow rates, an electrokinetic pump as described in US Patent applications US 2003-0206806, US 2004-0011648, Us 2004-0074768, US2005-0016853, or an electrokinetic flow controller, as described in Patents applications US 2002-0189947, US-2004-0163957, the contents of all of which are hereby incorporated herein by reference, can be used. The sample is pumped into the injector 184 of the liquid separation and detection system 180 before being passed to the electrochemical detection system 160.

The use of electrochemical detection for the analysis of catecholamines can be performed without derivatization, which greatly simplifies the analysis. The use of capillary liquid chromatography with the electrochemical detection system described herein allows for sensitive, rapid analyses. Additionally, by coupling microdialysis sampling, injection and separation into an on-line instrument, sample-handling problems such as evaporation can be avoided.

Assay Species for Purity:

Because the efficiency of the electrochemical reaction at the working electrode is very high, the electrochemical cell can be used to determine the purity of an electrochemically active species, provided that the contaminants are not electrochemically active. The electrical charge observed upon the complete oxidation or reduction of a known amount of analyte can be compared to the calculated value, and any discrepancies can be taken as an indication of impurity and the extent of the impurity. Alternatively, if all contaminants are known to be electrochemically active, then contaminant levels can be measured directly and quantitatively.

Electrochemical Immunoassay Sensor:

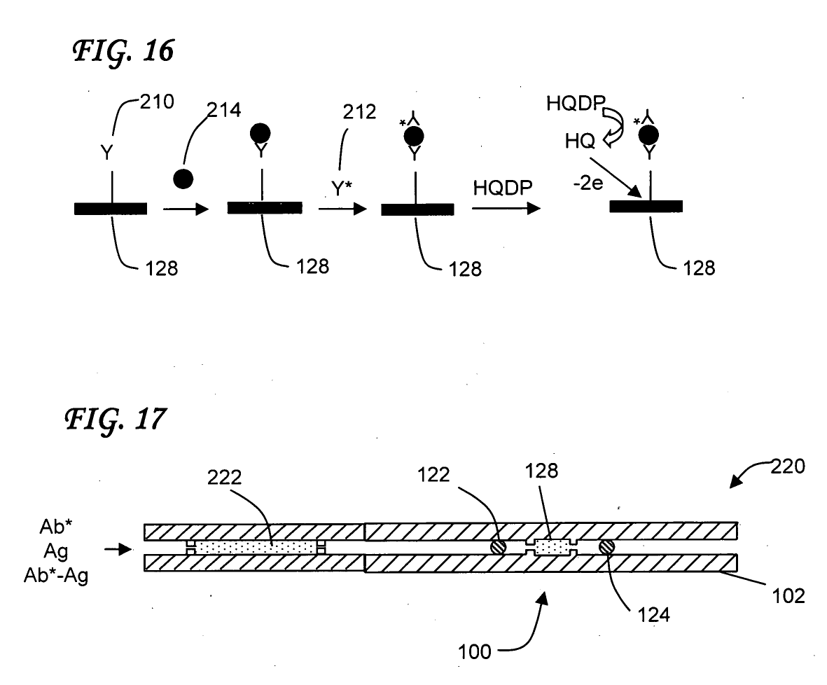

The root of protein detection lies in the development of an immunoassay, which is based on the high specificity that an antibody has for its target antigen. An electrochemical cell can be used for detecting proteins by electrochemical immunoassay. FIG. 16 is a schematic diagram showing the use of an electrochemical cell according to an embodiment of the present invention as an electrochemical immunoassay sensor. The cell contains a working electrode 128, with a capture antibody (Y) 210 bound thereto, and uses an alkaline-phosphatase (AP) based enzyme-linked immunosorbent assay (ELISA). The AP on the antibody (Y*) 212 generates electrochemically active hydroquinone at the surface of the working electrode. Detection is achieved by electrochemical oxidization of AP generated hydroquinone. The resulting current measured is proportional to the concentrations of the target analytes 214.

Protein Arrays:

Current high density protein arrays suffer from limited quantitation due to the challenge posed by the large number of antibody reagents required, the need for characterization of antibody reagents individually and in the complete system, their differing shelf life, stability and binding activities, and differing analyte concentration ranges. A microfabricated electrochemical based protein array overcomes these limitations. A small sample loading size, high selectivity and sensitivity of the electrochemical cell, and ease of fabrication make the electrochemical based protein array attractive.

An ultra sensitive, multichannel electrochemical flow immunoassay for the detection of proteins is illustrated in FIG. 17. The capture antibody (Ab*) is conjugated with electrochemically active species. The binding complex (Ab*-Ag) of the electrochemical labeled antibody to the target antigen can be detected using electrochemical cell according to the present invention, because the oxidization/reduction of the electrochemically active species give a current response on the working electrode surface. The binding complex can be easily separated with the free electrochemically labeled antibody through a resin column 222 before reaching the electrochemical cell 100. Since the array system is designed as multiple flow-through channels, no immobilization of the antibody on the electrode surface is involved, making the device fabrication simpler and more reproducible.

Method of Fabricating Electrochemical Cells

Preferably, the electrochemical cells according to the present invention are manufactured using the steps detailed below, although other methods known in the art can also be used, such as that described in A. Grosse, M. Grewe and H. Fouckhardt, “Deep Wet Etching of Fused Silica Glass for Hollow Capillary Optical Leaky Waveguides in Microfluidic Devices,” J. Micromech. Microeng. 11, 257 (2001) and that described in U.S. patent Ser. No. 10/198,223 entitled Laminated Flow Device, invented by David W. Neyer, Phillip H. Paul and Jason E. Rehm, both of which are incorporated herein by reference for any and all purposes.

A pair of wafers are cleaned unless already clean. Standard wafer sizes can be used, 0.5-1 mm thickness, 100 mm diameter, as well as any desired size. The wafer can be made of silicon, glass, silica, quartz, or other ceramic materials. Further, when using silica, glass or quartz wafers, a first surface of the pair of wafers is coated with a first layer of silicon. The layer can have a thickness of 1000-3000 Angstroms, for example. The layer can be applied via low-pressure chemical vapor deposition (LPCVD) as is known in the art. Amorphous silicon films are preferred over other choices like photoresist, chrome, chrome/gold or titanium/platinum combinations for their reliability in defining channels in a fused silica substrate without edge defects that result from etchant-induced adhesion failure or pinholes in the film.

A first pattern for micro-conduits is transferred into the first layer of silicon on both silica wafers. The pattern contains the primary flow path, the secondary conduits and the working electrode section. The pattern can be transferred using standard lithography methods. In a preferred embodiment, a lithography mask can be generated from a drawing of the desired micro-conduit pattern, typically by a commercial vendor using a chrome film (˜1000 Angstrom thick) on a glass substrate. If one mask is used, the same mask can be used for both wafers in the pair. Preferably, a single mask can be used that contains a mirror plane of symmetry for those micro-conduits that are desired to be approximately circular in cross-section. The micro-conduit pattern preferably is designed such that mirror-image alignment of the pattern on each wafer contains micro-conduit traces that substantially overlap in regions of the fluidic manifold where cylindrical channels are desired. If two masks are used, one is used for each wafer in the pair.

A thin film, 1-7 micrometers, for example, of photoresist (photosensitive polymer) is placed over the layer of amorphous silicon on the pair of silica wafers. The side of each silica wafer having the thin film of photoresist is placed proximal to or in contact with the mask. The desired microconduit pattern is transferred from the masks to the layers of photoresist by exposing the photoresist to UV light through the mask followed by appropriate development and curing of the photoresist. The microconduit pattern can be transferred from the photoresist to the silicon layer on each wafer by etching the exposed amorphous silicon with wet chemical etching, using a mixture of hydrofluoric, nitric, and acetic acid, for example, or dry chemical etching, using reactive ion etching with a low-pressure (˜15-mTorr) plasma of a mixture of gases that includes SF6, C2 C1F5 and Ar, for example, or other method known in the art.

After the first microconduit pattern is transferred into the first layer of silicon on both wafers, the first microconduit pattern is transferred into the first surface of the silica wafers so that each silica wafer has a patterned surface of conduits having a substantially semi-circular cross-section. This can be accomplished by wet chemical etching of the exposed regions of the silica. The wet chemical etching can be accomplished by timed submersion in a 49% solution of HF. Etch rates are typically on the order of 1.3 micrometers per minute for silica. As this etching process is isotropic, the microconduits that are formed in the wafers have a substantially semi-circular cross-section.

The photoresist can be removed using a mixture of sulfuric acid and hydrogen peroxide, for example. The first layer of silicon can be removed by dry or wet chemical etching, as described above. Depending on the exact design, multiple etches can be used in the fabrication of the microfluidic detection device. For example, a first etch can be a shallow etch of about 1.5 microns and a second etch can be a deep etch of about 56 microns. Thus, the process is repeated using a second mask.

The first etch can be used to define alignment marks on the wafers and any shallow structures that are to be incorporated into the design. The alignment marks are preferably shallow etched to provide improved alignment accuracy. In addition, the shallow etches can be used to provide regions of slightly larger diameter, i.e. 3 microns, when the regions that are shallow etched are subsequently deep etched.

The deep-etched regions are preferably etched approximately ±2 the diameter of the capillaries and optical fibers to be inserted plus about 1-2 micrometers to allow a minimal space for adhesive between the capillaries and optical fibers and the walls of the microconduit. For example, semicircular conduits having a radius of 56 micrometers are etched to make conduits having a circular cross-section with a 112 micrometer radius to accommodate capillaries and optical fibers having an outside diameter of 109 micrometers.

Preferably, the wafers are thoroughly cleaned with acid and base cleaning solutions so that surfaces of the pair of wafers are hydrophilic. In addition, the wafers preferably are also megasonically cleaned so that the surfaces of the wafers are more hydrophilic.

The first surfaces of each wafer are secured together so that the patterns on the first surfaces form the primary flow path and secondary conduits. The cleaned, patterned surfaces of the pair of silica wafers are substantially aligned and brought into contact so that the patterned surfaces form conduits having a substantially circular cross-section. Preferably, the alignment is accurate to within 3 micrometers. The patterned surfaces can be aligned using a commercially available wafer alignment device, such as the Electronic Visions EV520 aligner, which allows visual alignment of the two wafers while they are maintained co-planar with a very small separation by placing removable thin (40 microns) spacers between the wafers and avoiding contact of the two wafers prior to complete alignment through the adjustment of high precision positioning stages.

With the alignment complete, the wafers are clamped with the spacers remaining between the wafers. A modest pressure (approximately 2-20 psi) is applied at the center of the wafers, normal to the plane of the wafers. At this point, a weak attachment between the wafers occurs as indicated by the visually observable bonding front that moves from the center to the edge of the wafer. As the bonding front forms, the spacers are removed so that the entire wafer finishes bonding.

The pair of wafers is heated so that they bond together permanently. Heating the wafers (to approximately 1165° C. for silica wafers) for about 4-8 hours is sufficient to drive a dehydration reaction at the interface of the two wafers resulting in an interfacial bonding of the two wafers. The exact bonding temperature is dependant on the materials of construction of the wafer. The result is a strong wafer bond in which the interface essentially disappears and the resultant part is a solid component in which microconduits of substantially circular cross section exist for the introduction of fluid, capillaries, optical fibers, electrical leads, etc.

After bonding, the conduits can be filled with wax or some other suitable sacrificial material to avoid particulate contamination of the microconduits when the wafers are diced into multiple microfluidic cells. A diamond saw can be used to dice the wafers. Removal of the wax can be accomplished by pyrolysis of the wax. 650° is a sufficient temperature for pyrolysis. Since the cells can be very small, dicing a single pair of bonded silica wafers can yield a large number of cells and the cost of manufacture of the cells can be lessened. Lithography-based fabrication allows flexibility in the design and fabrication of the cells, allowing for low volume, low dispersion cells. It is straightforward to scale the electrode sizes up or down to address the needs of a particular application.

Once the cell substrate is fabricated, the counter electrodes 124, the reference electrodes 122 and the electrical connection 126 to the working electrode 128 are placed in appropriate secondary conduits. In an embodiment, platinum wires, which serve as the reference electrodes 122, the counter electrodes 124 and the electrical connection 126 to the working electrode 128, are placed into their conduits and sealed with an electrically inert material to prevent fluid leakage from the cell, with only a terminal of the electrode materials exposed to the primary flow path.

The weirs 134, 136 are formed in the microfabrication process by etching channels that define those features to an appropriate channel depth. Alternatively, the working electrode material can be retained by photopatterned microscale porous frits located at the weir positions. Such frits can be patterned using a means known in the art. Preferably, the frits possess uniform pore size distributions, wherein the average pore size is small enough to retain the working electrode material. The frits can be polymeric or ceramic in nature. Preferably, frit materials are chosen for minimal interaction with analyte sets to reduce the potential for data loss.

The working electrode 128 is fabricated by packing porous, conductive particles inside the working electrode section 132 through the filling conduit 120, then sealing the filling conduit with electrically inert material 138.

### EXAMPLES

The present invention will be better understood with reference to the following examples.

### Example 1

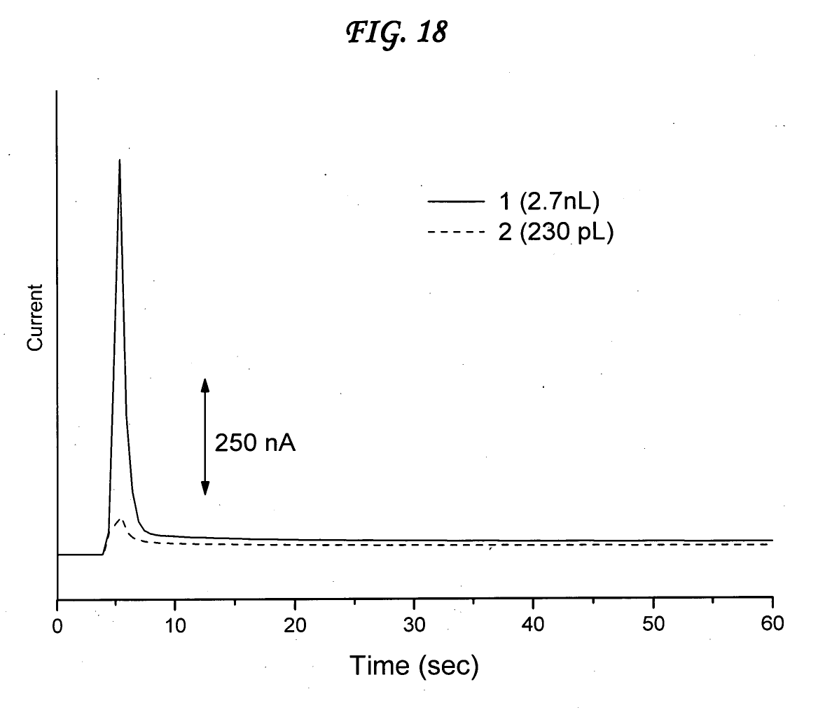

Example 1 illustrates the very fast start-up settling times of electrochemical cells according to the present invention. FIG. 18 shows a plot of electrical charging current as a function of time for two different electrochemical cells after the application of 300 mV (vs Pt) when platinum is employed as a reference electrode. Both cells consist of a fused silica body (3 mm×5 mm×1 mm in size) with porous graphitic particles as the working electrode substrate, two platinum reference electrodes (100 μm) and two platinum (100 μm) counter electrodes, configured according to the embodiment shown in FIG. 5a. One cell has an electrode section volume of 225 pL; the other has a volume of 2.7 nL. The current background at these electrodes is shown to be stable after approximately 10 seconds from the time the system is powered, due to small size of the electrodes.

### Example 2

Example 2 illustrates the selectivity of an electrochemical detection system according to the present invention by discrimination on each cell due to the different oxidation potentials of the analytes. A standard phenol mixture (100 μM) was dissolved in (50:50) water/ACN to form a sample solution. Mobile phase A consisted of 50 mM LiClO₄ in water, while mobile phase B consisted of 50 mM LiClO₄ in ACN; a 50:50 mix was used. The sample solution was introduced into an Eksigent ExpressLC system through a micro-injector (40 nL) and separated on an HPLC column (Eksigent Technologies, 300 μm i.d., 15 cm; 3 μm C18 particles). The eluent from the column was run sequentially through a low-dispersion UV detector (Eksigent Technologies) and then through an electrochemical detection system according to an embodiment of the present invention.

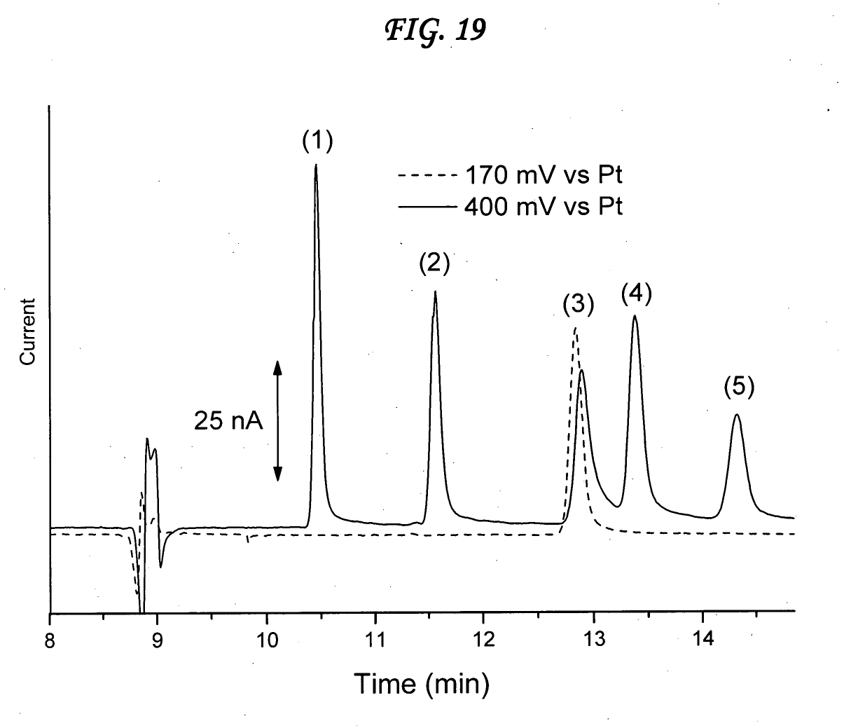

The electrochemical detection system had two independent cells in series, connected by a fused silica capillary. Each cell had two reference electrodes, two counter electrodes and a working electrode, configured according to the embodiment shown in FIG. 5a. Each cell had a cell volume of about 2.7 nL. FIG. 19 illustrates the separation of phenol (1) (E_{1/2}=336 mV vs Pt), 4-chloro-3-methylphenol (2) (E_{1/2}=314 mV vs Pt), 2-chlorophenol (3) (E_{1/2}=139 mV vs Pt), 2,4-dimethylphenol (4) (E_{1/2}=304 mV vs Pt) and 2,4-dichlorophenol (5) (E_{1/2}=305 mV vs Pt) with detection on the two serial cells operating at 170 mV and 400 mV (vs Pt). As shown, only the 2-chlorophenol (3) has significant signal on the first electrode while the second electrode detects the remaining species present in the sample.

### Example 3

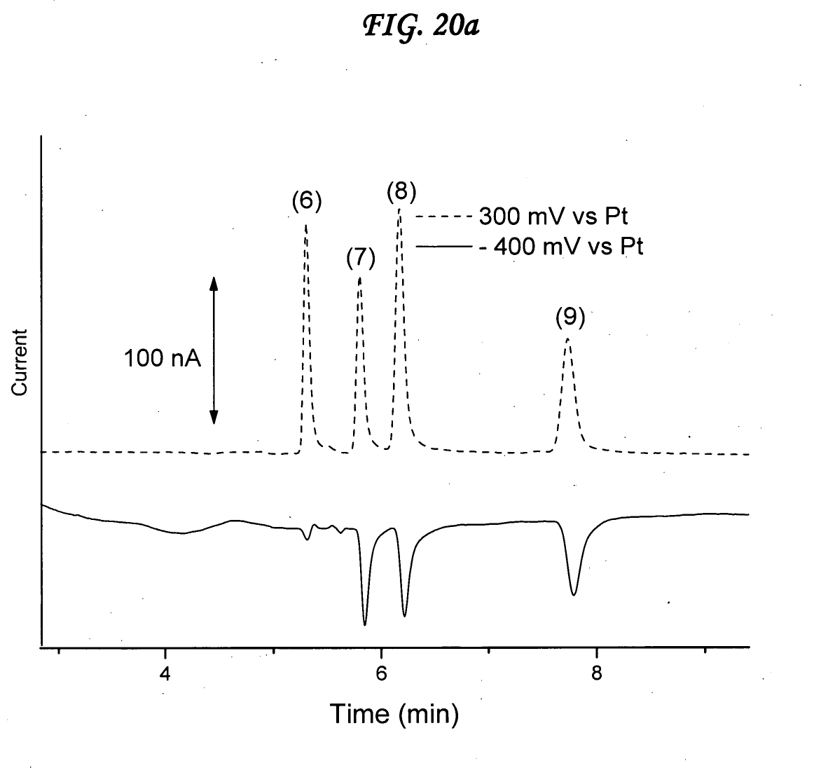

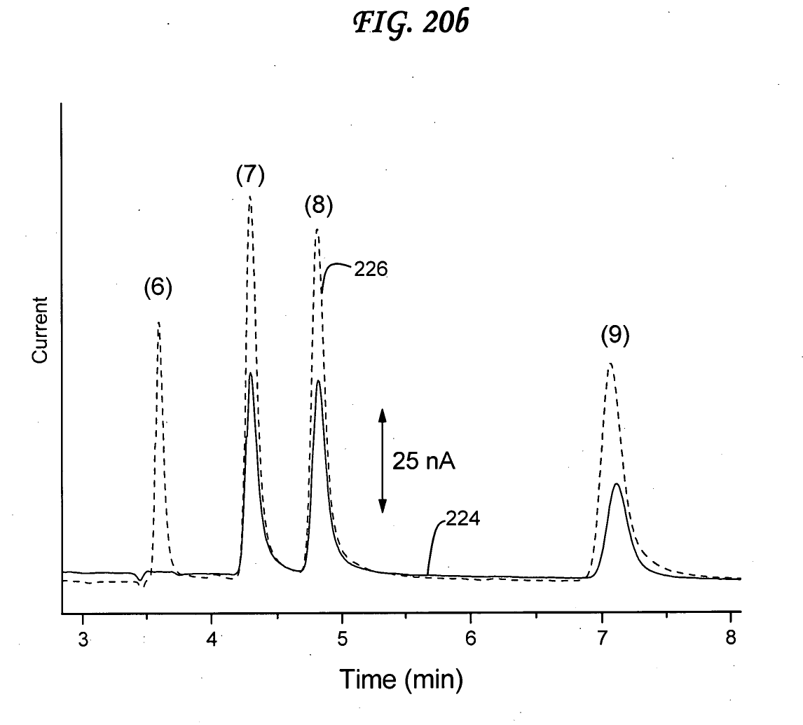

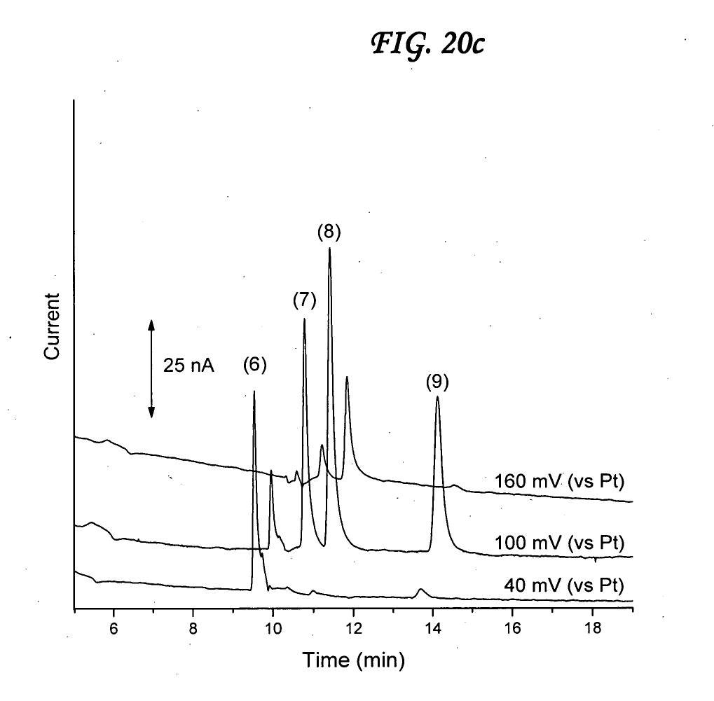

Stock solutions of ascorbic acid, norepinephrine, epinephrine, and dopamine were dissolved in acid and further diluted in water prior to analysis. Samples (5 pmol) were separated as in Example 2, with subsequent detection by the electrochemical detection system described in Example 2, with the exception that the mobile phases used in this analysis were 50 mM citrate, 50 mM acetate, 20 mg/L octane sulfonic acid, 224 mg/L EDTA (A) and methanol (B), run at 95:5 (A:B). In FIG. 20a two cells in series are shown, the first with an applied potential of 300 mV (vs Pt) and the second with an applied potential of −400 mV (vs Pt). As shown, the first cell provides a signal for ascorbic acid (6), norepinephrine (7), epinephrine (8) and dopamine (9), respectively. The second cell shows a signal for the reduction of the quasi-reversible catecholamines, but ascorbic acid is not seen due to its electrochemical irreversibility.

FIG. 20b illustrates a method for achieving selectivity based on charge. Stock solutions of ascorbic acid, norepinephrine, epinephrine, and dopamine were dissolved in acid and further diluted in water prior to analysis. Samples (5 pmol) were separated as in Example 2, with subsequent detection by the electrochemical detection system described in Example 2. In this example, two cells, a pretreatment cell followed by a detection cell, were again placed in series. The pretreatment cell was in an open circuit configuration, while the detection cell was held at 300 mV (vs Pt). As seen on trace 224, the pretreatment cell completely removed all traces of ascorbic acid (6), presumably due to its neutrality as opposed to the cationic catecholamines. A chromatographic trace 226 of an identical analysis performed in the absence of the pretreatment cell is also shown for clarity.

FIG. 20c illustrates selectivity based on electrochemical formal potential. Stock solutions of ascorbic acid, norepinephrine, epinephrine, and dopamine were dissolved in acid and further diluted in water prior to analysis. Samples (5 pmol) were separated as in Example 2, with subsequent detection by an electrochemical detection system according to an embodiment of the present invention. Three cells were arranged in series with staggered potentials (40 mV, 100 mV, 160 mV (vs Pt), respectively). FIG. 20c illustrates the discrimination on each cell due to the different oxidation potentials of ascorbic acid (6), norepinephrine (7), epinephrine (8) and dopamine (9), which allows for identification of species based on their electrochemical fingerprints.

### Example 4

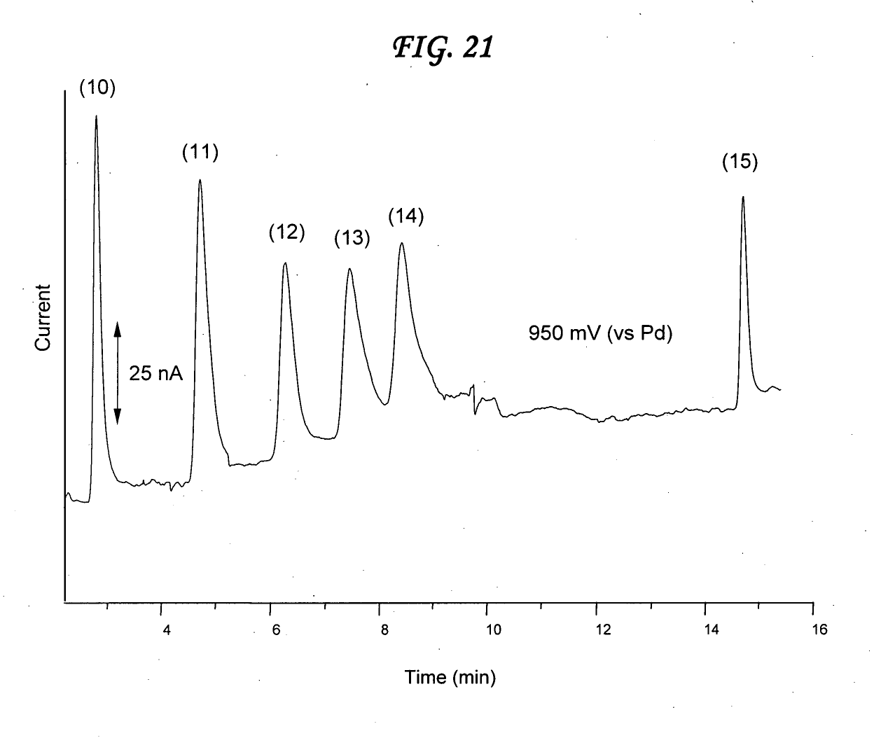

Gradient separation and detection of morphine, codeine, 6-acetyl-morphine, ethyl-morphine, cocaine and hydrocodone (0.8 ng each) with an electrochemical detection system according to an embodiment of the present invention is illustrated in FIG. 21. Samples were separated as in Example 2, with subsequent detection by the electrochemical detection system described in Example 2. The separation of morphine (10), codeine (11), 6-acetyl-morphine (12), ethyl-morphine (13), cocaine (14) and hydrocodone (15) was achieved by running isocratic with 20% mobile phase B until 8 min after the injection, then increasing mobile phase B to 50% at 15 min. The cell was held at 950 mV (vs Pd).

Although the present invention has been described in considerable detail with reference to certain preferred versions thereof, other versions are possible. Therefore, the spirit and scope of the appended claims should not be limited to the description of the preferred versions described herein.

All features disclosed in the specification, including the claims, abstracts and drawings, and all the steps in any method or process disclosed, can be combined in any combination except combination where at least some of such features and/or steps are mutually exclusive. Each feature disclosed in the specification, including the claims, abstract, and drawings, can be replaced by alternative features serving the same, equivalent or similar purpose, unless expressly stated otherwise. Thus, unless expressly stated otherwise, each feature disclosed is one example only of a generic series of equivalent or similar features.

Any element in a claim that does not explicitly state “means” for performing a specified function or “step” for performing a specified function, should not be interpreted as a “means” or “step” clause as specified in 35 U.S.C. §112.

What is claimed is:

1. An electrochemical cell for processing a sample fluid, the cell comprising:
A monolithic body having a flow path, the flow path having an inlet and an outlet;
a reference electrode in fluid communication with the flow path;
a counter electrode in fluid communication with the flow path;
a porous working electrode in fluid communication with the flow path, the working electrode comprising a working electrode material;
an electrical connection for the working electrode in electrical contact with the working electrode; and
a working electrode section in the flow path, the working electrode being positioned inside the working electrode section; and
wherein the working electrode section has a volume of from about 1 pL to about 1 μL.

2. The cell of claim 1 wherein the cell further comprises a filling conduit in fluid communication with the working electrode section for placement of the working electrode material; and
wherein the working electrode section is bounded by weirs, the weirs allowing passage of sample fluid and blocking passage of the working electrode material.

3. The cell of claim 2 wherein the body comprises fused silica.

4. The cell of claim 3 wherein the working electrode comprises particles having a diameter of from about 10 nm to about 100 μm.

5. The cell of claim 1 wherein the flow path has a volume of from about 1 nL to about 50 nL.

6. The cell of claim 1 wherein the reference electrode and the counter electrode further comprise non-reactive metal wire having a diameter of from about 5 μm to about 500 μm.

7. The cell of claim 6 wherein the reference electrode and the counter electrode comprise inert metal wire having a diameter of from about 25 μm to about 125 μm.

8. The cell of claim 1 wherein the reference electrode and the counter electrode comprise at least one of the group consisting of palladium, platinum and silver.

9. The cell of claim 8 wherein at least one of the reference electrode and the counter electrode comprise a porous polymeric coating.

10. The cell of claim 1 further comprising:
a second reference electrode in fluid communication with the flow path; and
a second counter electrode in fluid communication with the flow path.

11. The cell of claim 1 wherein the working electrode comprises at least one of carbon, copper, gold, palladium and platinum.

12. The cell of claim 1 wherein the working electrode comprises at least one of silver, indium tin oxide and tin oxide.

13. The cell of claim 1 wherein the flow path comprises an annular section around at least one of the counter electrode and the reference electrode.

14. An electrochemical detection system comprising:
a circuit board;
an electrochemical cell electrically coupled to the circuit board, the cell comprising:
a body having a flow path, the flow path having an inlet and an outlet;
a reference electrode in fluid communication with the flow path;
a counter electrode in fluid communication with the flow path;
a porous working electrode positioned in the flow path, the working electrode comprising a working electrode material;
an electrical connection for the working electrode in electrical contact with the working electrode; and
a working electrode section in the flow path, the working electrode being positioned inside the working electrode section;
wherein the working electrode section has a volume of from about 1 pL to about 1 μL;
a preamplifier electrically connected to the circuit board and the cell;
a connector electrically connected to the preamplifier; and
a housing surrounding the circuit board, the preamplifier and the connector.

15. The system of claim 14 further comprising:
a control and data acquisition system electrically connected to the connector;
a heater mounted to the housing and electrically connected to the control and data acquisition system; and
a sensor for sensing a housing temperature mounted to the housing and electrically connected to the control and data acquisition system;
wherein the control and data acquisition system controls the heater to heat the housing based upon the housing temperature sensed by the sensor.

16. The system of claim 14 further comprising a liquid chromatography column having an inlet and an outlet, the outlet of the liquid chromatography column being in fluid communication with the flow path inlet.

17. The system of claim 14 further comprising an interface to a mass spectrometer in fluid communication with the flow path outlet.

18. The system of claim 14 further comprising:
a second electrochemical cell, the outlet of the second cell being in fluid communication with the chromatography column inlet;
a sample injector in fluid communication with the inlet of the second cell; and
a solvent delivery system in fluid communication with the sample injector.

19. The system of claim 18 further comprising:
a solvent delivery system;
a second electrochemical cell in fluid communication with the solvent delivery system; and
a sample injector in fluid communication with the outlet of the second cell and the chromatography column inlet;
wherein the second cell is adapted to cleanse a solvent in the solvent delivery system.

20. An electrochemical detection system comprising:
a cell according to claim 1; and
a light detector;
wherein the cell converts at least one of an analyte and a reagent to a luminescent species detectable by the light detector.

21. An electrochemical detection system comprising:
a cell according to claim 1; and
a light source;
wherein the light source converts at least one of an analyte and a reagent to a species detectable by the cell.

22. An array of electrochemical cells comprising:
a monolithic body comprising silica and a flow path, the flow path having an inlet and an outlet;
a plurality of reference electrodes in fluid communication with the flow path;
a plurality of counter electrodes in fluid communication with the flow path;
a plurality of separate porous working electrodes positioned in the flow path; and
separate electrical connections for each of the working electrodes in electrical contact with the working electrodes.

23. The array of claim 22 comprising from about 2 to about 16 working electrodes.

24. An electrochemical detection system comprising:
first and second electrochemical cells, each cell further comprising:
a) a body having a flow path, the primary flow path having an inlet and an outlet;
b) a reference electrode in fluid communication with the flow path;
c) a counter electrode in fluid communication with the flow path;
d) a porous working electrode positioned in the flow path, the working electrode comprising a working electrode material; and
e) an electrical connection for the working electrode in electrical contact with the working electrode; and
f) a working electrode section in the flow path, the working electrode being positioned inside the working electrode section;
wherein the outlet of the first cell is in fluid communication with the inlet of the second cell; and
wherein each working electrode section has a volume of from about 1 pL to about 1 μL.

25. The system of claim 24 wherein the first cell has a first electric potential; the second cell has a second electric potential; and the first and second electric potentials are different.

26. A method for detecting samples from a sample fluid comprising the steps of:
selecting the electrochemical detection system of claim 14;
passing a solvent and the sample fluid through the liquid chromatography column; and
detecting the samples as the samples pass through the electrochemical cell.

27. A method for detecting samples from a sample fluid comprising the steps of:
selecting the electrochemical detection system of claim 18;
passing the sample fluid into the second electrochemical cell; and
using the second electrochemical cell as a microreactor for converting samples in the sample fluid.

28. A method for detecting samples from a sample fluid comprising the steps of:
selecting the electrochemical detection system of claim 18;
passing the sample fluid into the second electrochemical cell; and
using the second electrochemical cell to concentrate samples in the sample fluid.

29. A method for making an electrochemical cell comprising the steps of:
forming a monolithic body having a fluid manifold, the fluid manifold having a flow path, a working electrode section in the flow path, a filling conduit in communication with the working electrode section, and a plurality of secondary conduits in communication with the flow path;
packing a working electrode material into the working electrode section through the filling conduit to create a working electrode;
sealing the filling conduit with electrically non-reactive material;
mounting:
i) a reference electrode in a first of the secondary conduits;
ii) a counter electrode in a second of the secondary conduits; and
iii) an electrical connection to the working electrode in a third secondary conduit; and
sealing the secondary conduits with an electrically non-reactive material;
wherein the working electrode section has a volume of from about 1 pL to about 1 μL.

30. The method of claim 29 wherein the step of forming the body further comprising microfabricating weirs defining the working electrode section.

31. The method of claim 29 wherein the body is formed using photolithography.
